(19) United States
(12) Patent Application Publication
(10) Pub. No.: US 2015/0332219 A1
(43) Pub. Date: Nov. 19, 2015

(54) MERGER AND ACQUISITION FOR ACCEPTING AND DECLINING PARTS OF A MEETING

(71) Applicant: Cisco Technology, Inc., San Jose, CA (US)

(72) Inventors: David Putterman, Cambridge, MA (US); Brian Glanville, Shirley, MA (US); Konstas Yannakopoulos, Bolton, MA (US); Dhiren Patel, Berlin, MA (US); Prudvi Raj Dommaraju Ravindranath, Acton, MA (US)

(73) Assignee: Cisco Technology, Inc., San Jose, CA (US)

(21) Appl. No.: 14/276,314

(22) Filed: May 13, 2014

(51) Int. Cl. G06Q 10/10

(52) U.S. Cl. CPC G06Q 10/1095

(57) ABSTRACT

Presented herein are techniques for receiving, from each participant of a plurality of participants of a meeting, scheduling information indicating availability of each participant for each of a plurality of meeting segments corresponding to intervals of time spanning the duration of the meeting. The received scheduling information is aggregated for the plurality of participants. One or more status indicators that indicate the availability of each participant of the plurality of participants for each meeting segment are displayed.

### TECHNICAL FIELD

The present disclosure relates to online meeting/conference sessions.

### BACKGROUND

Online conference and meeting sessions provide a convenient way for participants in different geographical locations to communicate with one another. For example, using an online conference service, a first participant in a first location and a second participant in a second location may have the capability to communicate with one another using both audio and video communication. A participant can share documents or other content so that each participant may view the same content at the same time.

### BRIEF DESCRIPTION OF THE DRAWINGS

FIG. 1 is a block diagram of a system in which an online conference session may be supported according to an example embodiment.

FIG. 2 illustrates a ladder sequence diagram, depicting operations for receiving and processing meeting availability information according to an example embodiment.

FIG. 3A is an illustration of an example graphical user interface displaying a start time and an end time for a meeting along with input information to generate individual meeting segments of the meeting, according to an example embodiment.

FIG. 3B is an illustration of an example graphical user interface displaying a list of participants and status indicators, according to an example embodiment.

FIG. 3C is an illustration of an example display of meeting segments and corresponding status indicators for each segment, according to an example embodiment.

FIG. 3D is an illustration of an example display of aggregate meeting attendance information, according to an example embodiment.

FIG. 4 is a flowchart generally depicting operations for accepting and declining parts/segments of a meeting according to an example embodiment.

FIG. 5 is an example block diagram of an apparatus configured to receive and aggregate participant status information according to an example embodiment.

### DESCRIPTION OF EXAMPLE EMBODIMENTS

### Overview

Presented herein are techniques for receiving, from each participant of a plurality of participants of a meeting, scheduling information indicating availability of each participant for each of a plurality of meeting segments, the meeting segments corresponding to intervals of time spanning the duration of the meeting. The received scheduling information is aggregated for the plurality of participants. One or more status indicators that indicate the availability of each participant of the plurality of participants for each meeting segment are displayed.

### Example Embodiments

When in a meeting, such as an online conference meeting/session, participants may have conflicts during portions (segments) of the meeting. When such a scheduling conflict occurs, participants may accept the meeting invitation and send a comment to the moderator, indicating for which portions of the meeting there are conflicts. For large meetings with many participants, a moderator may have difficulty keeping track of the availability of each participant.

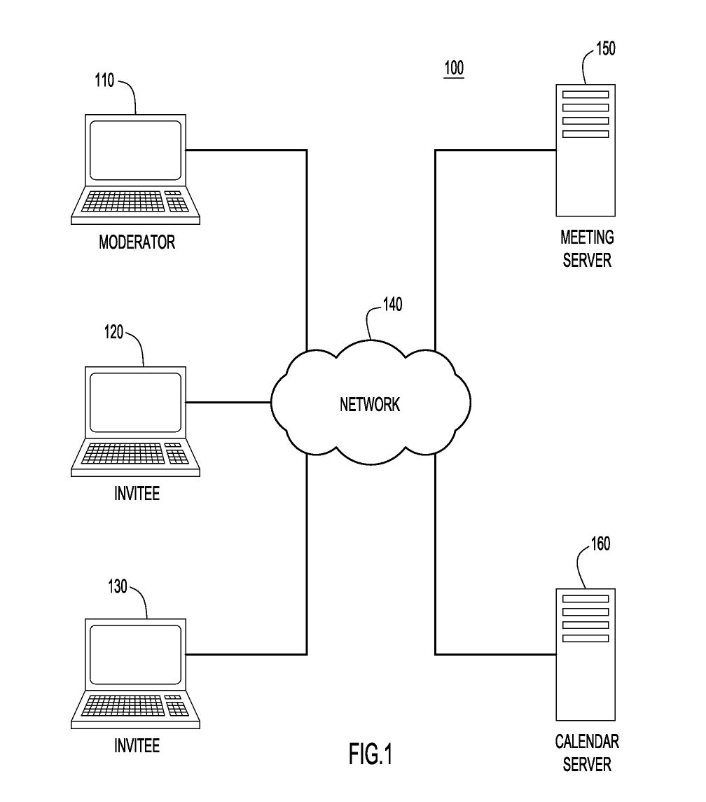

According to embodiments presented herein, participants may accept portions of a scheduled time period for a meeting. Status information for each segment of the meeting for each participant is aggregated and displayed to the meeting organizer. Having such information allows meeting organizers to organize meetings more efficiently, and target specific information to specific participants at specific times during the meeting. Status information for each segment, and for each participant, may be displayed in graphical form or numeric form. These techniques will be described more fully with reference to FIGS. 1-5 and the following description provided below.

FIG. 1 is a block diagram of a meeting system 100 including one or more user devices 110, 120 and 130 capable of communicating, via a network 140, with one or more servers, e.g., a meeting server 150 and a calendar server 160. The user devices may be a computer terminal, Smartphone, tablet computer, or any other device having a display screen and capable of supporting a communication session. Meeting server 150 is configured to host the online communication session. Calendar server 160, shown in FIG. 1 as a single server for simplicity, may maintain calendar information for one or more participants of a meeting, such as an online meeting session.

A moderator device 110 may send a request to meeting server 150 over the network 140 to schedule an online communication session with devices 120 and 130. Meeting server 150 receives and accepts requests from the moderator device 110, or other device having sufficient administrative privileges, to schedule a meeting, and when the scheduled time occurs, to establish and maintain an online conference session at the designated time. Meeting server 150 also synchronizes video and/or audio content of the online conference session between moderator device 110 and each participant at user devices 120 and 130.

Meeting server 150 also divides a meeting into time segments, based upon input from a moderator, and sends an invitation to each participant, with the invitation comprising status indicators for each segment of a meeting. Meeting server 150 then receives replies from participants, aggregates status information, and displays the results to the moderator.

Network 140 may include a combination of a local area network, wide area network (e.g., the Internet), and wireless network, that is capable of forwarding/routing messages and data between the moderator device 110, the one or more participant/user devices 120 and 130, the meeting server 150 and the calendar server 160. Additional features of the online conference session are described in additional detail below.

It is also understood that meeting server 150 may request calendar information from a plurality of calendar servers of different types. For example, meeting server 150 may request calendar information from calendars associated with email servers, online calendars, calendars maintained on mobile handheld devices, calendars associated with management software, or any such system containing scheduling information.

Further, system 100 is not intended to be limiting with regard to the particular communication session shown. The techniques presented are applicable to a virtually unlimited number of servers, e.g., a plurality of calendar servers, as well as a multitude of network configurations and a plurality of devices. Moreover, the embodiments presented herein are not limited to online meeting/conference sessions. The meeting could be an in-person meeting.

It is noted that the terms invitee, attendee, and participant are used interchangeably throughout this description.

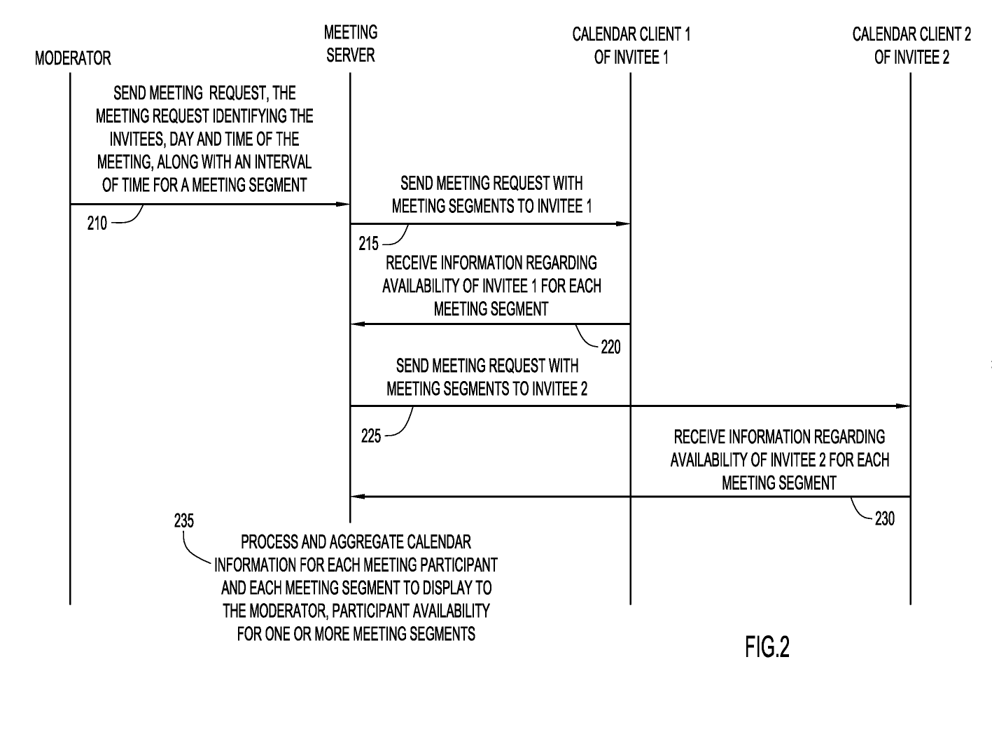

FIG. 2 shows a ladder sequence diagram according to examples of the techniques presented herein. In particular, FIG. 2 describes a sequence for gathering scheduling information across different calendar servers from multiple participants. In this example, calendar information is received from clients, e.g., including mobile applications, plugins, etc. A user may respond to a meeting request, indicating availability for one or more segments of a meeting via a calendar client and such status information is sent to the meeting server.

At operation 210, a meeting moderator sends a meeting request to a meeting server. The meeting request identifies the invitees as well as a day and time of the meeting, and individual intervals or increments of time for each of a plurality of meeting segments of the meeting. At operation 215, the meeting server sends a meeting invitation with a plurality of meeting segments (and corresponding status identifiers) to a calendar client 1 of invitee 1. At operation 220, notification that the calendar client of invitee 1 has accepted or declined one or more meeting segments is received (based upon input from invitee 1), along with status information regarding availability of invitee 1 for each meeting segment. At operation 225, (and at the same time as operation 215), a meeting request with a plurality of meeting segments (and corresponding status identifiers) is sent to a calendar client 2 of invitee 2. At operation 230, notification that the calendar client of invitee 2 has accepted or declined one or more meeting segments is received (based upon input from invitee 2), along with status information regarding availability of invitee 2 for each meeting segment. At operation 235, calendar information is processed and aggregated for each meeting participant and each meeting segment. The aggregated status information of participant availability for each of the individual meeting segments can be displayed to the moderator.

If scheduling information is updated by a participant after the meeting segment status information has been aggregated, then the calendar client for that participant may push an update or provide the information to meeting server 150 at the time the update occurs. The aggregate meeting segment status information is updated accordingly.

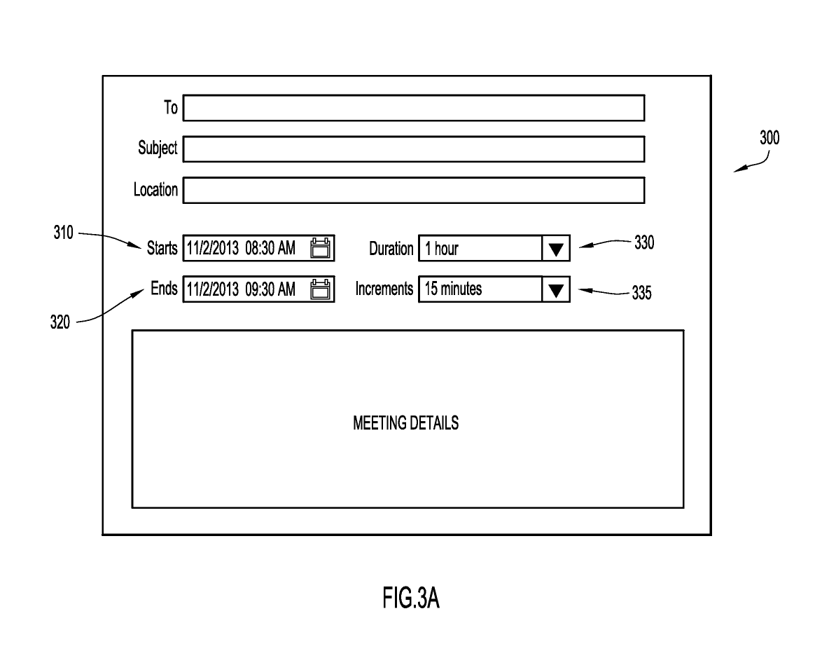

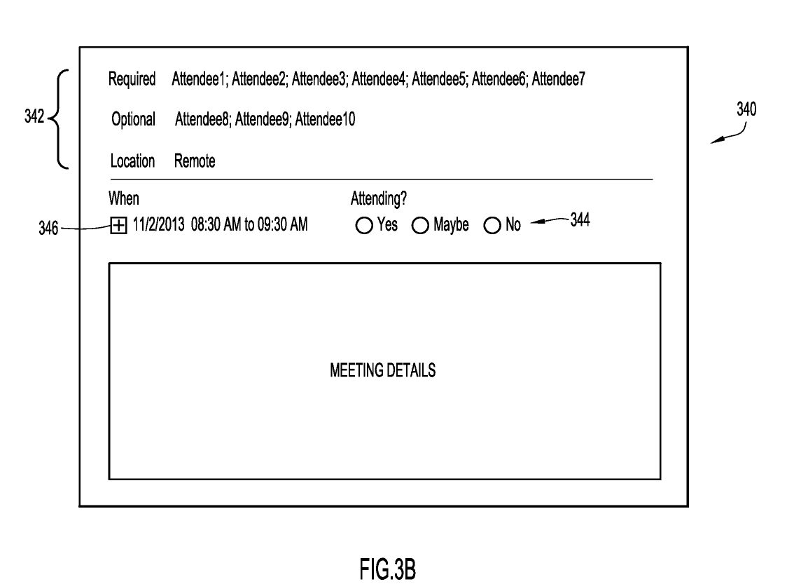

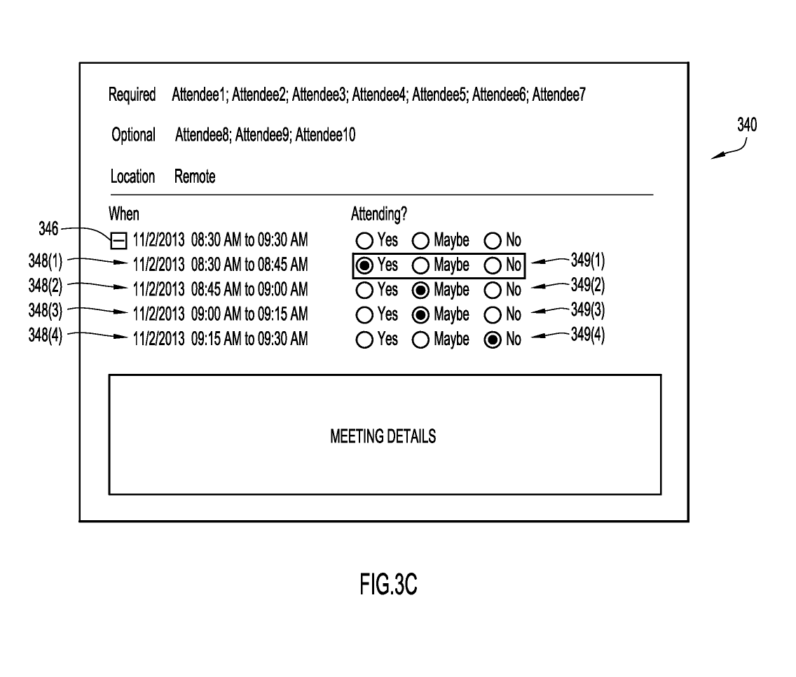

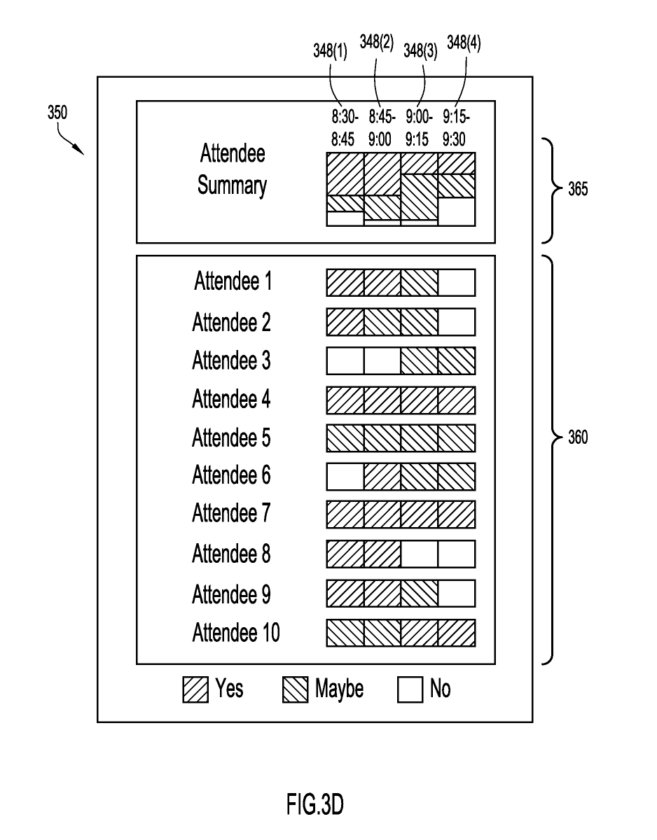

Reference is now made to FIGS. 3A-3D, which show examples of various graphical user interface screens that may be used as part of the process of determining and indicating participant availability for a plurality of meeting segments. FIG. 3A shows a graphical user display screen of a meeting invitation 300, by which a meeting moderator generates a meeting invitation to be sent to invitees of a meeting. In addition to the fields, e.g., “To”, “Subject”, “Location”, and “Meeting Details”, the meeting invitation 300 contains fields for specifying a start time 310, an end time 320, a meeting duration 330, and increments of time 335, which determine the length of time of the meeting segments. The increments of time for individual meeting segments may be set to any desired increment of time, e.g., 15 minutes, 30 minutes, etc. The increments of time 335 are used to divide the meeting into (non-overlapping or overlapping) meeting segments and for which participant status information is tracked on a segment-specific basis.

FIG. 3B shows a graphical display screen of a meeting invitation 340 received by a participant. The meeting invitation may be sent to a plurality of invitees/participants, with invitees/participants being categorized as “Required” or “Optional” as shown at reference numeral 342. Each participant may indicate availability to attend the meeting for one or more periods of time. If a participant is able to attend the entire meeting, the participant may select status identifier 344, e.g., “Yes”, “No”, or “Maybe”, for the entire duration of the meeting. It is noted that in this case, the drop down icon, indicated by a “+” sign shown at 346 has not been selected, and therefore, the response sets availability for the entire duration of the meeting. That is, the status identifier will be applied to all meeting segments.

Referring to FIG. 3C, if a participant is not able to attend the entire meeting or wishes to view the individual meeting segments to indicate segment-specific availability, the participant may select drop down icon “+” 346, to display the plurality of meeting segments associated with the meeting. In this example, for a meeting of 1 hour and with increments designated to be 15 minutes, the four 15 minute meeting segments 348(1)-348(4) are generated based on the moderator configurations set as described in connection with FIG. 3A. The meeting segments are adjacent and may or may not overlap in time, to span the entire duration of the meeting. Each meeting segment 348(1)-348(4) has a corresponding status identifier 349(1)-349(4), respectively, indicating whether a participant is available for a particular meeting segment. For example, a participant may select “Yes”, “Maybe”, or “No” for a status indicator for a corresponding meeting segment. Thus, a participant may accept, decline or indicate a tentative status for each segment of a meeting. Each segment of the meeting may be associated with a unique identifier (ID), with the unique ID used to correlate each meeting segment to the original meeting. An invitee/participant may select a status identifier for each segment of the meeting independently from the other meeting segments. For example, a participant may accept or decline non-consecutive portions of a meeting, e.g., accept the first meeting segment and the third meeting segment, etc.

Referring to FIG. 3D, a graphical element 350 is shown that includes aggregate status identifier information for each participant for each meeting segment. For example, the response of each participant/attendee of the meeting, attendee(1)-attendee(10), for each meeting segment 348(1)-348(4) is shown at 360. For example, attendee 1 has indicated a status of “Yes” for the first two meeting segments 348(1) and 348(2), a status of “Maybe” for the third meeting segment 348(3), and a status of “No” for the last meeting segment 348(4). Based upon this information and the unique ID, the meeting organizer is easily able to discern which attendees are available for which meeting segments, and can tailor the contents of the meeting to specific personnel during specific meeting segments. The status information may be color coded, with “Yes” being green, “No” being red and “Maybe” being blue, as an example.

Attendance summary information 365 is shown at the top portion of FIG. 3D. The attendee summary provides an indication of how many participants are available, not available, or possibly/tentatively available, for each meeting segment. In order to aggregate this status information, a unique identifier may be associated with each meeting segment. The identifier ties the status to a particular attendee and a particular meeting segment, and allows the results of each meeting segment to be combined.

Many other such combinations are possible, and are understood to fall within the scope of the techniques disclosed herein.

As a more specific example, meeting 12346 may be configured to be from 9 a.m.-10 a.m. If the meeting moderator sets the increment to be 15 minutes, then 4 meeting segments are generated, corresponding to meeting segment 1 at 9:00 am-9:15 am, meeting segment 2 at 9:15 am-9:30 am, meeting segment 3 at 9:30 am-9:45 am, and meeting segment 4 at 9:45 am-10:00 am. In this example, the unique ID is “Increment ID”. Corresponding data for the meeting may be:

| IncrementStartTime | IncrementEndTime | ParentMeeting | IncrementID |
|---|---|---|---|
| 9:00 am | 9:15 am | 12346 | 11111 |
| 9:15 am | 9:30 am | 12346 | 11112 |
| 9:30 am | 9:45 am | 12346 | 11113 |
| 9:45 am | 10:00 am | 12346 | 11114 |

A particular user may indicate availability for the first two meeting segments, tentative availability for the 9:30 am-9:45 am meeting segment and no availability for the 9:45 am-10:00 am meeting segment. Corresponding data, including unique status identifiers may be shown as:

| userID | incrementID | Status |
|---|---|---|
| user1 | 11111 | ACCEPT |
| user1 | 11112 | ACCEPT |
| user1 | 11113 | TENTATIVE |
| user1 | 11114 | DECLINE |

Other storage and database schema are possible as well.

Thus, based upon status indicators that indicate the availability of each participant, for example, as shown in FIG. 3D, a moderator or other authorized participant can plan the meeting to cover the most important material at times when most participants are present, and cover material that needs specific participant feedback when a specific participant is present.

The attendance summary may display information indicating a number or percentage of participant acceptance, tentative acceptance, and/or rejection for each of a plurality of meeting segments. For example, in FIG. 3D, the combined responses of meeting attendees are shown in graphical format as stacked columns for each meeting segment, with each response represented by a fixed height within the stacked column. Thus, for a given category of a response, the meeting segment having the greatest height within the stacked column will represent the meeting segment having the most participant responses for that category. This information is displayed in graphical format, as a percentage. As an example, the last meeting segment 348(4) displays a higher number of rejections than any other meeting segment, as indicated by the height of the “No” response of the stacked column graph, which is 2-4 times higher than the number of rejections of the other columns. Given that four of the ten attendees have rejected this meeting segment, the height of the “No” response of the stacked column is shown as 40% of the total possible height.

Similarly, the attendance summary may display an indicator of highest acceptances for a meeting segment. For example, in FIG. 3D, first and second segments, 348(1) and 348(2) both show stacked columns with a higher number of acceptances (e.g., the number of acceptances for the first and second meeting segments are the same) than any other segment of the meeting. The height of the stacked column corresponds to 60% of the total height, corresponding to 6 of 10 acceptances.

While FIG. 3D shows combined response rates in graphical format, combined response rates may also be shown in any suitable numeric format, e.g., percentages, ratios, etc.

In other embodiments, the meeting moderator may be automatically notified by the meeting server, as to which meeting segment has the highest or lowest number of participant acceptances.

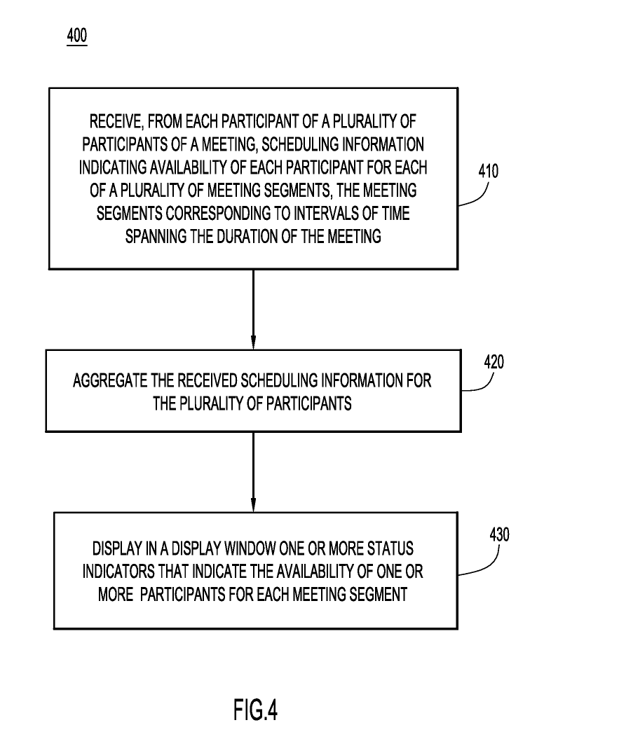

FIG. 4 shows a high-level/generalized flowchart 400 of operations performed by meeting server 150 according to the techniques described herein. At operation 410, scheduling information is received, from each participant of a plurality of participants of a meeting, e.g., an online conference session. The scheduling information indicates availability of each participant for each of a plurality of meeting segments, the meeting segments corresponding to intervals (non-overlapping or overlapping) of time spanning the duration of the meeting. At operation 420, the received scheduling information from the plurality of participants is aggregated. At operation 430, one or more status indicators are displayed in a display window to indicate the availability of one or more participants for each meeting segment.

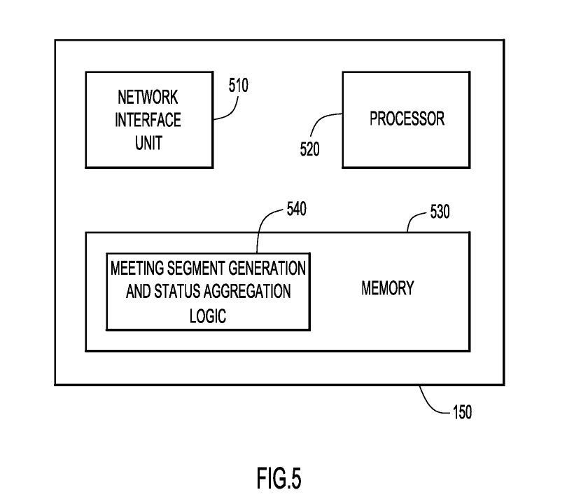

FIG. 5 illustrates an example block diagram of an apparatus, meeting server 150, configured to perform the techniques presented herein. The meeting server 150 includes a network interface unit 510, a processor 520, and a memory 530. The network interface unit 510 is configured to enable network communications over a network to send data to user devices in an online conference session (video, audio as well as overlaid graphics, e.g., the graphics shown in FIG. 3D). The network interface unit 510 also receives data (audio, video, shared document data, etc.) from the user devices.

The processor 520 may be embodied by one or more microprocessors or microcontrollers, and executes software instructions stored in memory 530 for meeting segment generation and status aggregation logic 540 to perform the operations described above in connection with FIGS. 1-4.

Memory 530 may be embodied by one or more computer readable storage media that may comprise read only memory (ROM), random access memory (RAM), magnetic disk storage media devices, optical storage media devices, flash memory devices, electrical, optical, or other physical/tangible memory storage devices.

Thus, in general, the memory 530 may comprise one or more tangible (e.g., non-transitory) computer readable storage media (e.g., a memory device) encoded with software comprising computer executable instructions, and when the software is executed by the processor 520, the processor 520 is operable to perform the operations described herein in connection with meeting segment generation and status aggregation logic 540. Meeting segment generation and status aggregation software/logic 540, as disclosed herein, determines availability of each participant for a plurality of meeting segments, and aggregates availability information to be displayed to the host.

The functions of the processor 520 may be implemented by logic encoded in one or more tangible computer readable storage media or devices (e.g., storage devices compact discs, digital video discs, flash memory drives, etc. and embedded logic such as an ASIC, digital signal processor instructions, software that is executed by a processor, etc.).

While FIG. 5 shows that the meeting server 150 may be embodied as a dedicated physical device, it should be understand that the functions of the server 150 may be embodied as software running in a data center/cloud computing system, together with numerous other software applications.

The techniques presented herein may apply to any resources that are commonly shared, and are not limited to the specific examples disclosed herein.

Advantages of the techniques presented herein include indicating a status for multiple increments of a meeting, and not necessarily consecutive segments of a meeting. A meeting organizer may easily visualize the expected attendance of users through a new interface. Participants may accept and decline portions of meetings for any reason, not just meeting overlaps. Further, the present techniques allow a structured way to accept and decline portions of a meeting, as well as display this information to the host so the host does not need to manually keep track of attendance, e.g., through text based emails.

The techniques presented herein provide a computer-implemented method, apparatus and computer readable media of receiving, from each participant of a plurality of participants of an online conference session, scheduling information indicating availability of each participant for each of a plurality of meeting segments, the meeting segments corresponding to intervals of time spanning the duration of the meeting. The received scheduling information from the plurality of participants is aggregated, and one or more status indicators that indicate the availability of one or more participants for each meeting segment is displayed in a display window.

Although the apparatus, system, and computer-implemented method are illustrated and described herein as embodied in one or more specific examples, it is nevertheless not intended to be limited to the details shown, since various modifications and structural changes may be made therein without departing from the scope of the apparatus, system, and computer-implemented method and within the scope and range of equivalents of the claims. Accordingly, it is appropriate that the appended claims be construed broadly and in a manner consistent with the scope of the apparatus, system, and computer-implemented method, as set forth in the following claims.

To summarize, a computer-implemented method is provided comprising receiving, from each participant of a plurality of participants of a meeting, scheduling information indicating availability of each participant for each of a plurality of meeting segments, the meeting segments corresponding to intervals of time spanning a duration of the meeting; aggregating the received scheduling information from the plurality of participants; and displaying in a display window one or more status indicators that indicate the availability of one or more participants for each meeting segment.

Likewise, an apparatus is provided comprising a network interface unit configured to send and receive communications over a network; and a processor coupled to the network interface unit, and configured to: obtain, from each participant of a plurality of participants of a meeting, scheduling information indicating availability of each participant for each of a plurality of meeting segments, the meeting segments corresponding to intervals of time spanning a duration of the meeting; aggregate the received scheduling information from the plurality of participants; and generate for display in a display window one or more status indicators that indicate the availability of one or more participants for each meeting segment.

Further still, one or more computer-readable storage media are provided encoded with software comprising computer executable instructions and when the software is executed operable to: obtain, from each participant of a plurality of participants of a meeting, scheduling information indicating availability of each participant for each of a plurality of meeting segments, the meeting segments corresponding to intervals of time spanning a duration of the meeting; aggregate the received scheduling information from the plurality of participants; and generate for display in a display window one or more status indicators that indicate the availability of one or more participants for each meeting segment.

The above description is intended by way of example only. Various modifications and structural changes may be made therein without departing from the scope of the concepts described herein and within the scope and range of equivalents of the claims.

What is claimed is:

1. A computer-implemented method comprising:
receiving, from each participant of a plurality of participants of a meeting, scheduling information indicating availability of each participant for each of a plurality of meeting segments, the meeting segments corresponding to intervals of time spanning a duration of the meeting;
aggregating the received scheduling information from the plurality of participants; and
displaying in a display window one or more status indicators that indicate the availability of one or more participants for each meeting segment.

2. The method of claim 1, wherein receiving comprises receiving scheduling information indicating participant availability, wherein availability of a particular meeting segment is selected independently from other meeting segments.

3. The method of claim 1, wherein receiving comprises receiving scheduling information indicating that a participant has accepted or declined two or more nonadjacent meeting segments.

4. The method of claim 1, wherein receiving comprises receiving scheduling information from one or more calendar servers that maintain calendar information for one or more participants.

5. The method of claim 1, further comprising displaying meeting status summary information in graphical format, wherein the meeting status summary information displays combined scheduling information for each participant and for each meeting segment.

6. The method of claim 1, further comprising displaying an indicator of a percentage of participant acceptance among the plurality of participants for each meeting segment.

7. The method of claim 6, further comprising displaying an indicator of a lowest percentage of acceptance for a meeting segment.

8. The method of claim 1, further comprising:
determining a meeting segment having a highest percentage of acceptance among the plurality of meeting segments; and
notifying a meeting moderator of the meeting segment with the highest percentage of acceptance.

9. An apparatus comprising:
a network interface unit configured to send and receive communications over a network; and
a processor coupled to the network interface unit, and configured to:
obtain, from each participant of a plurality of participants of a meeting, scheduling information indicating availability of each participant for each of a plurality of meeting segments, the meeting segments corresponding to intervals of time spanning a duration of the meeting;
aggregate the received scheduling information from the plurality of participants; and
generate for display in a display window one or more status indicators that indicate the availability of one or more participants for each meeting segment.

10. The apparatus of claim 9, wherein the processor is further configured to obtain scheduling information indicating participant availability, wherein availability of a particular meeting segment is selected independently from other meeting segments.

11. The apparatus of claim 9, wherein the processor is further configured to obtain scheduling information indicating that a participant has accepted or declined two or more nonadjacent meeting segments.

12. The apparatus of claim 9, wherein the processor is further configured to obtain scheduling information from one or more calendar servers that maintain calendar information for one or more participants.

13. The apparatus of claim 9, wherein the processor is further configured to generate for display meeting status summary information, wherein the meeting status summary information displays combined scheduling information for each participant and for each meeting segment.

14. The apparatus of claim 9, wherein the processor is further configured to generate for display an indicator of a percentage of participant acceptance among the plurality of participants for each meeting segment.

15. The apparatus of claim 9, wherein the processor is further configured to:
determine a meeting segment having a highest percentage of acceptance among the plurality of meeting segments; and
notify a meeting moderator of the meeting segment with the highest percentage of acceptance.

16. One or more computer-readable storage media encoded with software comprising computer executable instructions and when the software is executed operable to:
obtain, from each participant of a plurality of participants of a meeting, scheduling information indicating availability of each participant for each of a plurality of meeting segments, the meeting segments corresponding to intervals of time spanning a duration of the meeting;
aggregate the received scheduling information from the plurality of participants; and
generate for display in a display window one or more status indicators that indicate the availability of one or more participants for each meeting segment.

17. The computer-readable storage media of claim 16, further comprising instructions operable to obtain scheduling information indicating that a participant has accepted or declined two or more nonadjacent meeting segments.

18. The computer-readable storage media of claim 16, further comprising instructions operable to generate for display meeting status summary information in graphical format, wherein the meeting status summary information displays combined scheduling information for each participant and for each meeting segment.

19. The computer-readable storage media of claim 16, further comprising instructions operable to generate for display an indicator of a percentage of participant acceptances among the plurality of participants for each meeting segment.

20. The computer-readable storage media of claim 16, further comprising instructions operable to:
determine a meeting segment having a highest percentage of acceptance among the plurality of meeting segments; and
notify a meeting moderator of the meeting segment with the highest percentage of acceptance.
